(19) United States
(12) Patent Application Publication
(10) Pub. No.: US 2020/0170053 A1
(43) Pub. Date: May 28, 2020

(54) METHOD FOR IDENTIFYING A FIELD DEVICE

(71) Applicant: Endress+Hauser Conducta GmbH+Co. KG, Gerlingen (DE)

(72) Inventors: Roman Griesser, Gerlingen (DE); Christian Felcmann, Mühlacker (DE); Stefan Robl, Hünxe (DE); Martin Lohmann, Gerlingen (DE); Tilman Benkert, Stuttgart (DE); Bo Ottersten, Regensburg (DE)

(21) Appl. No.: 16/689,274

(22) Filed: Nov. 20, 2019

(30) Foreign Application Priority Data
Nov. 23, 2018 (DE) 10 2018 129 595.2

(51) Int. Cl. H04W 76/11; H04W 76/14; H04W 4/80

(52) U.S. Cl. CPC H04W 76/11; H04W 4/80; H04W 76/14

(57) ABSTRACT

The present disclosure discloses a method for identifying a single field device in a list on a mobile device, such as on a display of a mobile device. The method includes steps of displaying on the mobile device a list of all field devices which can be reached in the same communication network as the mobile device and selecting a specific field device by physically interacting therewith. The method also includes steps of sending an identifier from the selected field device to the mobile device via the communication network and identifying the selected field device in the list of all field devices.

### CROSS-REFERENCE TO RELATED APPLICATION

The present application is related to and claims the priority benefit of German Patent Application No. 10 2018 129 595.2, filed on Nov. 23, 2018, the entire contents of which are incorporated herein by reference.

### TECHNICAL FIELD

The present disclosure relates to a method for identifying a single field device in a list on a mobile device.

### BACKGROUND

Measuring systems with field devices and mobile devices in which the mobile device is used, for example, to configure the field device are known. A connection between the field device and the mobile device is established either in a wired manner, for example also via the control system, or a wireless manner. In both cases, it may happen that the user connects by means of the mobile device to a different field device than expected. In the case of a wired connection, this is done, for example, because, although the cable is connected, the wrong address is entered in the mobile device. In the case of a wireless connection, a connection to the wrong field device is established.

In order to check to which field device the mobile device is connected, the HART field bus, for example, offers the squawk command: The mobile device sends the squawk command to the field device. Upon receipt of the squawk command, the field device emits an acoustic or optical signal. The user can thus check whether he is connected to the correct device.

However, the squawk command has disadvantages. The connection between mobile device and transmitter (field device) must already be established in order to be able to check whether the correct transmitter was selected during the connection process. And during the connection process, many transmitters may be selectable by the user. He must know in advance the necessary connection information in order to be able to select the correct transmitter at all.

### SUMMARY

The present disclosure is based on the aim of enabling the identification of a field device on a mobile device in a simple manner.

The aim is achieved by a method comprising the steps of: displaying on the mobile device, such as on a display of the mobile device, a list of all the field devices which can be reached in the same communication network as the mobile device; selecting a specific field device by physically interacting therewith; sending an identifier from the selected field device to the mobile device via the communication network; and identifying, optionally highlighting, the selected field device in the list of all field devices.

The list is a device list of all reachable field devices.

An application, also called an app which is able to display all reachable field devices runs on the mobile device. Optionally, this application is also capable of performing certain operations, such as configuration or calibration, on or with the field device.

Thus, the user goes to the field device with which he wants to work. The user interacts with it in a specific manner so that the corresponding entry in the list on the mobile device is marked. The user can then select this field device, establish a connection, and optionally work with it.

This leads to a reduction in the necessary connection information of the correct field device and to a simplification of the selection among the available field devices. This leads to a faster finding of his device in the app.

In addition, no bidirectional connection between field device and mobile device is necessary.

One embodiment provides that the communication network is a wired or wireless communication network, such as Bluetooth, WLAN, such as from the IEEE 802.11 family, LoRaWAN, a mobile radio network, LAN, PROFIBUS DP/PA, FoundationFieldbus, PROFINET, Ethernet/IP, HART, wirelessHART, etc.

One embodiment provides for the communication network to be two-part. Or in other words, access to the communication network by field device and mobile device takes place in different ways. In one embodiment, the field device is connected to the communication network in a wired manner, such as via LAN, and the mobile device is connected to the communication network wirelessly, such as via WLAN.

One embodiment provides that the communication network is Bluetooth from version 4.0 with the low energy protocol stack, and the transmission of the identifier from the selected field device to the mobile device takes place by means of advertising events on at least one advertising channel.

One embodiment provides that the method further comprises the following steps of: establishing a point-to-point connection between the selected field device and the mobile device, and working with the selected field device via the mobile device.

One embodiment provides that the field device comprises at least one button or key, and the physical interaction is the pressing of the button or key or a combination of several buttons or keys on the field device.

One embodiment provides that the field device comprises a microphone, vibration sensor, motion sensor, or acceleration sensor, and the physical interaction is a knocking on the field device, or rocking, shaking, rotating, or moving of the field device, or a response of the field device; the field device may, for example, comprise voice recognition.

One embodiment provides that the field device comprises a display, such as a touchscreen display or capacitive display, and the physical interaction is the touching of the display or a gesture on the display.

One embodiment provides that the field device comprises a motion sensor or a camera, and the physical interaction is a movement or gesture in the recording area of the motion sensor or of the camera.

One embodiment provides that the field device comprises a microphone, and the physical interaction is speaking or playing, for example, a code word, into the microphone.

One embodiment provides that the field device comprises an optical receiver, and the physical interaction is the irradiation of an optical signal, such as from a light source, such as a laser pointer.

The aim is further achieved by a measuring system for carrying out a method as described above, the measuring system comprising at least one field device and at least one mobile device.

### BRIEF DESCRIPTION OF THE DRAWINGS

This is explained in more detail with reference to the following figures.

FIG. 1 shows an embodiment of the claimed measuring system for carrying out the method;

FIG. 2 shows another embodiment of the claimed measuring system for carrying out the method;

FIG. 3 shows another embodiment of the claimed measuring system for carrying out the method;

FIG. 4 shows another embodiment of the claimed measuring system for carrying out the method;

FIG. 5 shows another embodiment of the claimed measuring system for carrying out the method;

FIG. 6 shows another embodiment of the claimed measuring system for carrying out the method;

FIG. 7 shows another embodiment of the claimed measuring system for carrying out the method;

FIG. 8 shows another embodiment of the claimed measuring system for carrying out the method; and

FIG. 9 shows another embodiment of the claimed measuring system for carrying out the method.

In the figures, the same features are identified with the same reference signs.

### DETAILED DESCRIPTION

The claimed measuring system in its entirety has the reference sign 1. The measuring system 1 comprises at least one field device 2 and one mobile device 3. Shown on the right-hand side of the figures is an enlarged view of a display 4 of the mobile device 3.

The mobile device 3 is designed, for example, as a smart phone, tablet, phablet, or laptop, etc. In one embodiment, the mobile device is designed as a PC.

The field device 2 is designed as a sensor for use in process automation. This sensor is, for example, a pH sensor, also referred to as an ISFET, generally an ion-selective sensor, a sensor for measuring the redox potential, the oxygen, such as dissolved oxygen, the conductivity, or the temperature with the respectively corresponding measured variable. A transmitter is also to be understood as field device 2. The sensor can furthermore be designed as a flow, fill level, limit, or pressure sensor.

Work with the field device 2 can be done via the mobile device 3. It is thus possible, for example, to configure the field device 2 or to carry out a calibration with the mobile device 3.

The mobile device 3 and the field device 2 can be reached via the same communication network 5. In the example, the communication network is a Bluetooth connection. The Bluetooth connection is designed at least in version 4.0 and thus comprises the low energy protocol stack.

Other possible communication networks 5 are those of mobile radio, such as GSM, GPRS, EDGE, UMTS, HSDPA, LTE, or 5G. Other possible communication networks 5 are wireless communication networks, such as WLAN, such as from the IEEE 802.11 family, LoRaWAN, or wirelessHART. Wired communication networks 5, such as LAN, PROFIBUS DP/PA, FoundationFieldbus, PROFINET, Ethernet/IP, or HART are possible in one embodiment.

In fact, a plurality of field devices 2 can be reached in the same communication network 5. The communication network is indicated by the arrow with reference sign “5.” The Bluetooth logo is indicated by way of example.

All field devices 2 comprise the Bluetooth low energy protocol stack and independently periodically send short advertising events (advertising messages) on one of the three possible advertising channels (registration channels). The field device subsequently listens on this channel for a connection request. The mobile device 3 periodically listens on one of the three channels for a specific period of time each, the channel being changed after a specific interval. The procedure is successful as soon as a packet falls into a reception phase. The two periods for the transmission of packets (advertising interval) and for receiving (scan interval) and the duration of a reception phase (scan window) can be freely selected by a device within certain limits. These field devices 2 are thus basically reachable via the Bluetooth communication network 5.

Via these advertising events, certain data are already sent from the field device 2 to the mobile device 3. This can be, for example, an identifier of the field device 2. The status of the field device, for example, according to the NAMUR recommendation NE 107 (i.e., “normal,” “maintenance required,” “outside the measuring range,” “function check (output signal temporarily not allowed), and “error”), the type of field device (pH sensor, conductivity sensor, transmitter, etc.), or the main measured value can also be transmitted via an advertising event.

This results in a list 7 of field devices 2 which can be reached or are located in the same communication network 5 as the mobile device 3. In the case of Bluetooth, as mentioned, no mutual or general registration is necessary initially. In other communication networks 5, such as WLAN or according to a mobile radio standard, a registration is first carried out in the communication network 5.

The user 6 now wants to identify a very specific field device 2 via the mobile device 3. This is not possible only on the basis of list 7 since the list does not show which device is the desired field device 2.

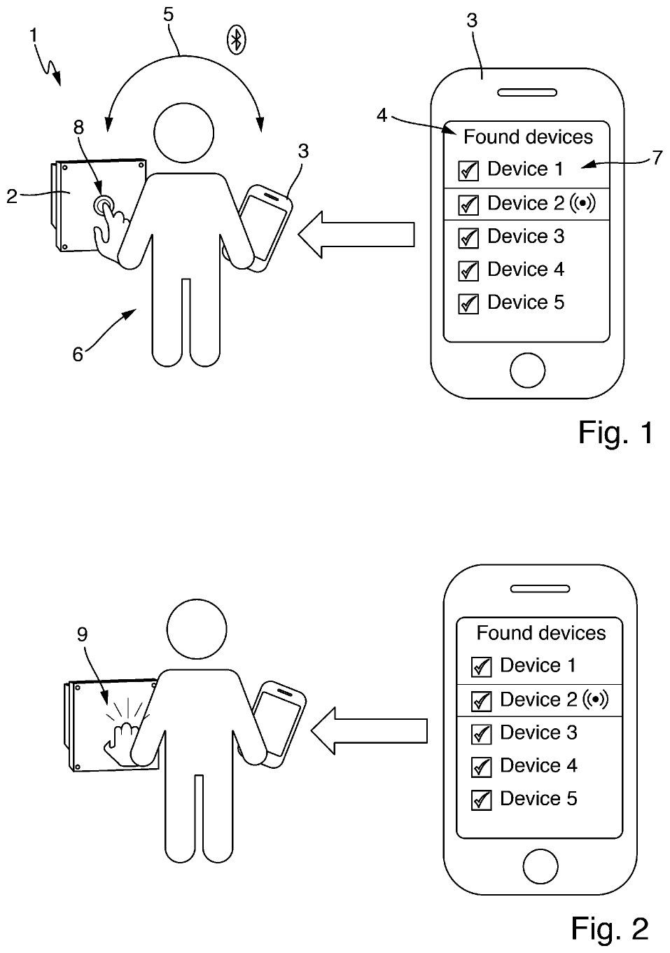

FIGS. 1 to 9 show various possibilities for the solution.

FIG. 1 shows the user 6 as he presses a button 8 on the field device 2. By this physical action on the field device 2 itself, the field device is identified in the list 7 on the mobile device 3. This is done, for example, by highlighting or marking the field device 2 in the display 4. In general, physical interaction on the field device 2 triggers a clear identification of the field device 2 on the mobile device 3.

A physical action on the field device 2 enables identification of the field device 2 on the mobile device. For example, optional information that precisely the one field device 2 is to be selected is sent to the mobile device 3 in the advertising event.

In the figures described below, only the reference signs changed in comparison to FIG. 1 are indicated in each case.

FIG. 2 shows that the field device 2 comprises a microphone, vibration sensor, motion sensor, or acceleration sensor 9, and that the physical interaction is a knocking on the field device 2, or rocking, shaking, rotating, or moving of the field device 2.

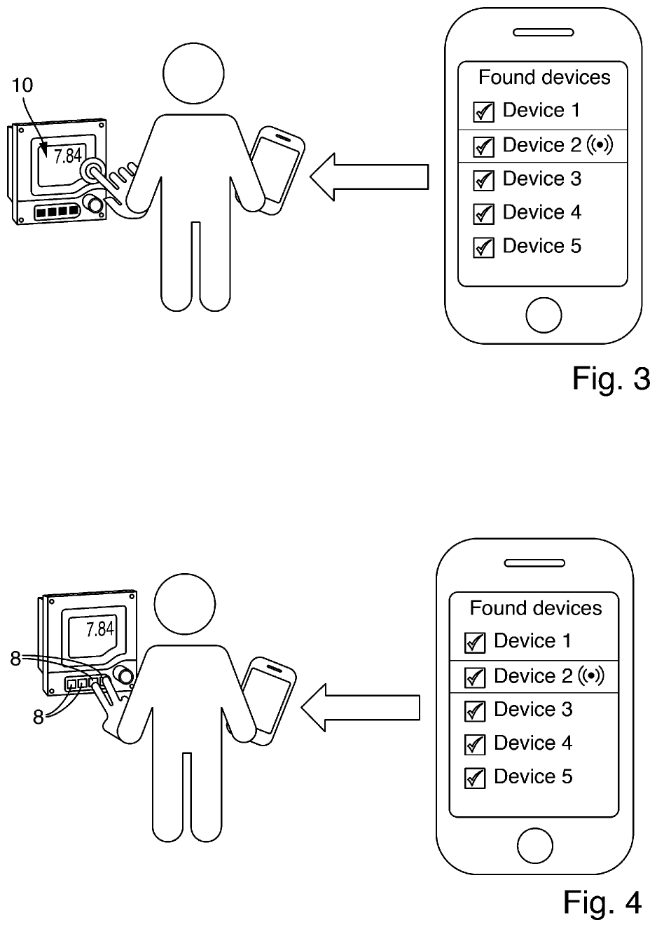

FIGS. 3 and 8 show that the field device 2 comprises a touchscreen display 10, and that the physical interaction is the touching of the touchscreen display 10 (FIG. 3) or a gesture on the touchscreen display 10 (FIG. 8). In one embodiment, the display is designed as a capacitive display.

FIG. 4 shows that the field device 2 comprises one or more buttons 8 or keys, and that the physical interaction is the pressing of the button 8 or key or a combination of several buttons or keys on the field device.

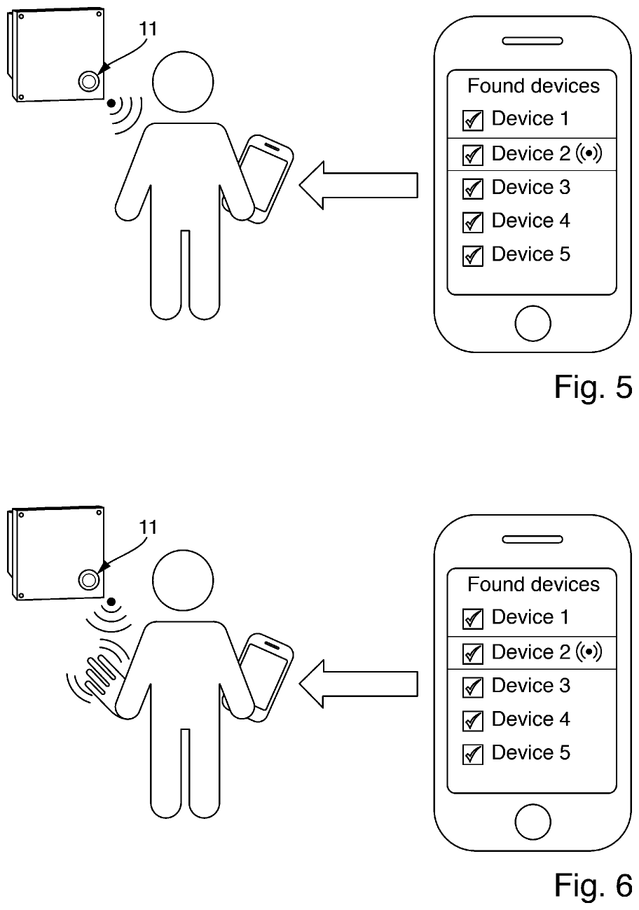

FIGS. 5 and 6 show that the field device 2 comprises a motion sensor 11 or a camera, and the physical interaction is a movement in the recording area of the motion sensor 11 or of the camera (FIG. 5) or that a gesture (FIG. 6) is carried out in the recording area of the motion sensor 11 or of the camera.

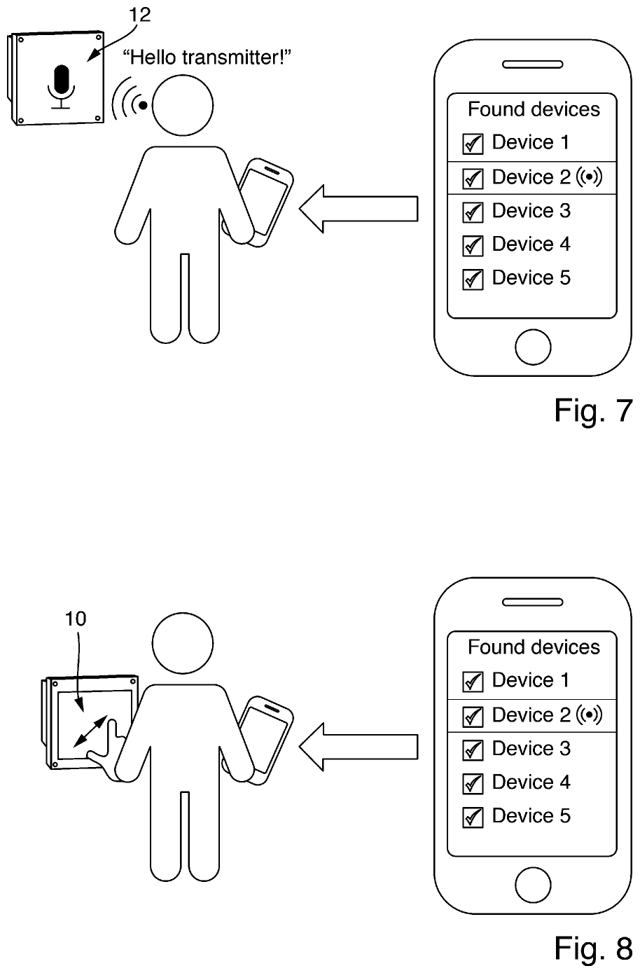

FIG. 7 shows that the field device 2 comprises a microphone 12 and that the physical interaction is speaking or playing, for example, a code word, into the microphone 12.

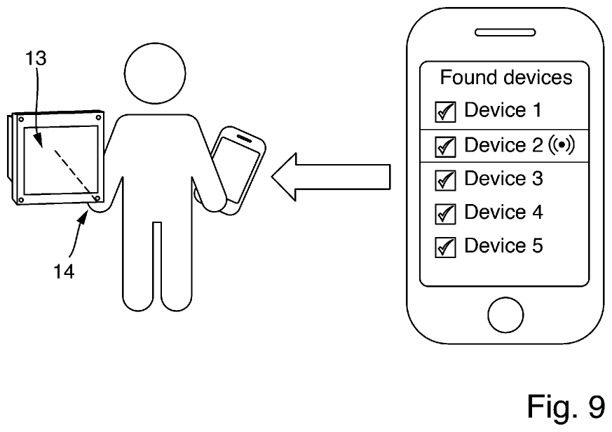

FIG. 9 shows that the field device 2 comprises an optical receiver 13, and that the physical interaction is the irradiation of an optical signal, such as from a light source, for example, from a laser pointer 14.

1. A method for identifying a single field device in a list on a mobile device, comprising the steps of:
displaying on the mobile device a list of all field devices which can be reached in the same communication network as the mobile device,
selecting a specific field device by physically interacting with the specific field device;
sending an identifier from the selected field device to the mobile device via the communication network, and
identifying the selected field device in the list of all field devices.

2. The method of claim 1, wherein the communication network is a wired or wireless communication network.

3. The method of claim 2, wherein the communication network is Bluetooth from version 4.0 with the low energy protocol stack, and the transmission of the identifier from the selected field device to the mobile device takes place via advertising events on at least one advertising channel.

4. The method of claim 1, further comprising steps of:
establishing a point-to-point connection between the selected field device and the mobile device, and
working with the selected field device via the mobile device.

5. The method of claim 1, wherein the field device comprises at least one button or key, and the physical interaction is the pressing of the button or key or a combination of several buttons or keys on the field device.

6. The method of claim 1, wherein the field device comprises a microphone, vibration sensor, motion sensor, or acceleration sensor, and the physical interaction is a knocking on the field device, or rocking, shaking, rotating, or moving of the field device.

7. The method of claim 1, wherein the field device comprises a display and the physical interaction is the touching of the display or a gesture on the display.

8. The method of claim 1, wherein the field device comprises a motion sensor or a camera, and the physical interaction is a movement or gesture in the recording area of the motion sensor or of the camera.

9. The method of claim 1, wherein the field device comprises a microphone, and the physical interaction is speaking or playing into the microphone.

10. The method of claim 1, wherein the field device comprises an optical receiver, and the physical interaction is the irradiation of an optical signal from a light source.

11. A measuring system for carrying out a method for identifying a single field device in a list on a mobile device, comprising:
the mobile device displaying a list of all field devices which can be reached in the same communication network as the mobile device;
a selected field device of all the field devices is selected by physically interacting a user or the mobile device with the specific field device;
the selected field device sending an identifier from the selected field device to the mobile device via the communication network, and
the selected field device identified in the list of all field devices.
